(19) United States
(12) Patent Application Publication
(10) Pub. No.: US 2024/0180181 A1
(43) Pub. Date: Jun. 6, 2024

(54) COATING COMPOSITIONS INCLUDING WAX

(71) Applicant: Apeel Technology, Inc., Goleta, CA (US)

(72) Inventor: Daniel Essert, Goleta, CA (US)

(21) Appl. No.: 18/517,148

(22) Filed: Nov. 22, 2023

Related U.S. Application Data
(60) Provisional application No. 63/427,753, filed on Nov. 23, 2022.

(51) Int. Cl. A23B 7/16; A23B 7/154; A23L 3/3517

(52) U.S. Cl. CPC A23B 7/16; A23B 7/154; A23L 3/3517

(57) ABSTRACT

The present disclosure relates to compositions including a wax and one or more salts of fatty acids. An exemplary embodiment includes about 20 wt % to about 98 wt % of a wax, and about 2 wt % to about 40 wt % of one or more salts of a C₄-C₂₈ fatty acid.

### CROSS-REFERENCE TO RELATED APPLICATION

This application claims the benefit of priority to U.S. Application No. 63/427,753, filed on Nov. 23, 2022, which is incorporated by reference herein in its entirety.

### TECHNICAL FIELD

The present disclosure relates to coatings for agricultural products.

### BACKGROUND

Common agricultural products are susceptible to degradation and decomposition (i.e., spoilage) when exposed to the environment. Such agricultural products can include, for example, eggs, fruits, vegetables, produce, seeds, nuts, flowers, and/or whole plants (including their processed and semi-processed forms). Non-agricultural products (e.g., vitamins, candy, etc.) are also vulnerable to degradation when exposed to the ambient environment. The degradation of the agricultural products can occur via abiotic means as a result of evaporative moisture loss from an external surface of the agricultural products to the atmosphere, and/or oxidation by oxygen that diffuses into the agricultural products from the environment, and/or mechanical damage to the surface, and/or light-induced degradation (i.e., photodegradation). Furthermore, biotic stressors such as, for example, bacteria, fungi, viruses, and/or pests can also infest and decompose the agricultural products.

Conventional approaches to preventing degradation, maintaining quality, and increasing the life of agricultural products include refrigeration and/or special packaging. Refrigeration requires capital-intensive equipment, demands constant energy expenditure, can cause damage or quality loss to the product if not carefully controlled, and must be actively managed. Also, benefits of refrigeration can be lost upon interruption of a temperature-controlled supply chain. Special packaging can also require expensive equipment, consume packaging material, increase transportation costs, and require active management. Despite the benefits that can be afforded by refrigeration and special packaging, the handling and transportation of the agricultural products can cause surface abrasion or bruising that is aesthetically displeasing to the consumer and can serve as a point of ingress for bacteria and fungi. Moreover, the expenses associated with such approaches can add to the cost of the agricultural product.

### SUMMARY

Provided herein is a composition including a wax, present in an amount of about 20 wt % to about 98 wt % of the composition, and one or more salts of a C₄-C₂₈ fatty acid, present in a total amount of about 2 wt % to about 40 wt % of the composition.

Also provided herein is a composition including a wax and one or more salts of a C₄-C₂₈ fatty acid. A ratio of a total mass of the wax to a total mass of the one or more salts is about 50:1 to about 3:1.

Also provided herein is a composition including a wax, one or more salts of a C₄-C₂₈ fatty acid, and one or more monoglycerides of a C₄-C₂₈ fatty acid. A ratio of a total mass of the wax to a total mass of the one or more salts is about 40:1 to about 2:1, and a ratio of the total mass of the wax to a total mass of the one or more monoglycerides is about 8:1 to about 1:1.

Also provided herein is a composition including a wax, one or more salts of a C₄-C₂₈ fatty acid, and one or more monoglycerides of a C₄-C₂₈ fatty acid. A ratio of a total mass of the wax to a total mass of the one or more salts is about 6:1 to about 1:1, and a ratio of the total mass of the wax to a total mass of the one or more monoglycerides is about 4:1 to about 1:1.

Also provided herein is a mixture of a composition described herein and a solvent.

Also provided herein is a coated agricultural product including an agricultural product and a layer disposed on a surface of the agricultural product, the layer including a composition described herein.

Also provided herein is a method of coating an agricultural product, the method including contacting a surface of the agricultural product with a mixture including a coating agent and a solvent, and removing at least a portion of the solvent to form a coating on the surface of the agricultural product. The coating agent a wax, present in an amount of about 20 wt % to about 98 wt % of the coating agent, and one or more salts of a C₄-C₂₈ fatty acid, present in a total amount of about 2 wt % to about 40 wt % of the coating agent.

Also provided herein is a method of coating an agricultural product, the method including contacting a surface of the agricultural product with a mixture described herein, and removing at least a portion of the solvent to form a coating on the surface of the agricultural product.

Although the disclosed inventive concepts include those defined in the attached claims, it should be understood that the inventive concepts can also be defined in accordance with the following embodiments.

Embodiment 1 is a composition comprising:
a wax, present in an amount of about 20 wt % to about 98 wt % of the composition; and
one or more salts of a C₄-C₂₈ fatty acid, present in a total amount of about 2 wt % to about 40 wt % of the composition.

Embodiment 2 is the composition of embodiment 1, wherein the wax is present in an amount of about 40 wt % to about 98 wt % of the composition.

Embodiment 3 is the composition of embodiment 1, wherein the wax is present in an amount of about 60 wt % to about 98 wt % of the composition.

Embodiment 4 is the composition of any of embodiments 1-3, wherein the one or more salts are present in a total amount of about 2 wt % to about 25 wt % of the composition.

Embodiment 5 is the composition of any of embodiments 1-3, wherein the one or more salts are present in a total amount of about 2 wt % to about 15 wt % of the composition.

Embodiment 6 is the composition of embodiment 1, wherein:
the wax is present in an amount of about 75 wt % to about 98 wt % of the composition; and
the one or more salts are present in a total amount of about 2 wt % to about 25 wt % of the composition.

Embodiment 7 is the composition of any of embodiments 1-6, further comprising one or more monoglycerides of a C₄-C₂₈ fatty acid.

Embodiment 8 is the composition of embodiment 7, wherein the one or more monoglycerides are present in a total amount of about 1 wt % to about 45 wt % of the composition.

Embodiment 9 is the composition of embodiment 7, wherein the one or more monoglycerides are present in a total amount of about 1 wt % to about 26 wt % of the composition.

Embodiment 10 is the composition of embodiment 7, wherein the one or more monoglycerides are present in a total amount of about 1 wt % to about 20 wt % of the composition.

Embodiment 11 is the composition of embodiment 7, wherein:
the wax is present in an amount of about 58 wt % to about 75 wt % of the composition; the one or more salts are present in a total amount of about 2 wt % to about 25 wt % of the composition; and
the one or more monoglycerides are present in a total amount of about 10 wt % to about 40 wt % of the composition.

Embodiment 12 is the composition of embodiment 7, wherein:
the wax is present in an amount of about 35 wt % to about 60 wt % of the composition;
the one or more salts are present in a total amount of about 10 wt % to about 30 wt % of the composition; and
the one or more monoglycerides are present in a total amount of about 15 wt % to about 35 wt % of the composition.

Embodiment 13 is a composition comprising:
a wax; and
one or more salts of a C₄-C₂₈ fatty acid,
   wherein a ratio of a total mass of the wax to a total mass of the one or more salts is about 50:1 to about 3:1.

Embodiment 14 is the composition of embodiment 13, further comprising one or more monoglycerides of a C₄-C₂₈ fatty acid, wherein a ratio of the total mass of the wax to a total mass of the one or more monoglycerides is about 100:1 to about 3:1.

Embodiment 15 is a composition comprising:
a wax;
one or more salts of a C₄-C₂₈ fatty acid; and
one or more monoglycerides of a C₄-C₂₈ fatty acid,
   wherein a ratio of a total mass of the wax to a total mass of the one or more salts is about 40:1 to about 2:1, and a ratio of the total mass of the wax to a total mass of the one or more monoglycerides is about 8:1 to about 1:1.

Embodiment 16 is a composition comprising:
a wax;
one or more salts of a C₄-C₂₈ fatty acid; and
one or more monoglycerides of a C₄-C₂₈ fatty acid,
   wherein a ratio of a total mass of the wax to a total mass of the one or more salts is about 6:1 to about 1:1, and a ratio of the total mass of the wax to a total mass of the one or more monoglycerides is about 4:1 to about 1:1.

Embodiment 17 is the composition of any of embodiments 14-16, wherein the wax, the one or more salts, and the one or more monoglycerides make up at least 80 wt % of the composition.

Embodiment 18 is the composition of any of embodiments 1-17, wherein the wax comprises beeswax, carnauba wax, candelilla wax, sunflower wax, or any combination thereof.

Embodiment 19 is the composition of any of embodiments 1-17, wherein the wax comprises beeswax.

Embodiment 20 is the composition of any of embodiments 1-19, wherein the wax comprises one or more wax esters.

Embodiment 21 is the composition of embodiment 20, wherein one or more of the wax esters independently comprises a compound of Formula III:

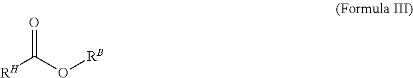

wherein:

each R^{B} is:
C₂₄-C₃₂ alkyl or C₂₄-C₃₂ alkenyl, each optionally substituted with 1-3 R^{C}, or

—R^{H}C(O)OR^{D};

each R^{C} is independently —OH, —C(O)OR^{D}, or —OC(O)R^{H};

each R^{D} is H or R^{B}; and

each R^{H} is independently a C₁₁-C₁₉ side chain optionally substituted with 1-3 R^{C}.

Embodiment 22 is the composition of embodiment 21, wherein each R^{H} is a saturated side chain.

Embodiment 23 is the composition of any of embodiments 20-22, wherein the one or more wax esters comprise one or more monoesters, present in a total amount of about 40 wt % to about 100 wt % of the one or more wax esters.

Embodiment 24 is the composition of embodiment 23, wherein one or more of the monoesters independently comprises a C₃₆ to C₅₄ monoester.

Embodiment 25 is the composition of embodiment 23 or embodiment 24, wherein the one or more wax esters further comprise one or more diesters, present in a total amount of about 5 wt % to about 50 wt % of the one or more wax esters.

Embodiment 26 is the composition of any of embodiments 23-25, wherein the one or more wax esters further comprise one or more triesters, present in a total amount of about 0.5 wt % to about 15 wt % of the one or more wax esters.

Embodiment 27 is the composition of any of embodiments 20-26, wherein the one or more wax esters make up about 50 wt % to about 100 wt % of the wax.

Embodiment 28 is the composition of any of embodiments 20-27, wherein the wax further comprises one or more alkanes.

Embodiment 29 is the composition of embodiment 28, wherein:
the wax comprises one or more C₂₄-C₃₆ alkanes; and
the one or more wax esters and the one or more C₂₄-C₃₆ alkanes make up about 60 wt % to about 100 wt % of the wax.

Embodiment 30 is the composition of any of embodiments 20-29, wherein the wax further comprises one or more compounds of Formula IV:

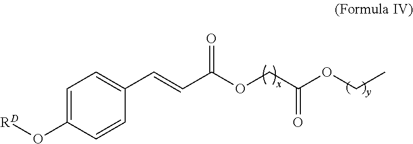

wherein:

R^{D} is H or C₁ alkyl; and

the sum of x and y is from 28 to 88.

Embodiment 31 is the composition of embodiment 30, wherein the one or more wax esters and the one or more compounds of Formula IV make up about 60 wt % to about 100 wt % of the wax.

Embodiment 32 is the composition of any of embodiments 1-31, wherein each of the one or more salts present in the composition independently comprises a compound of Formula II:

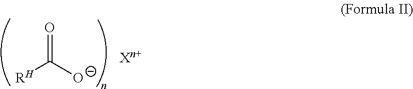

wherein:

R^{H} is a C₃-C₂₇ side chain; and

Xⁿ⁺ is a cationic moiety having formal charge n.

Embodiment 33 is the composition of embodiment 32, wherein:
Xⁿ⁺ is selected from Li⁺, Na⁺, K⁺, Cs⁺, Ag⁺, Ca²⁺, Mg²⁺, Zn²⁺, Cu²⁺, and (R^{D})₄N⁺; and each occurrence of R^{D} is selected from H, C₁-C₆ alkyl, C₃-C₆ cycloalkyl, C₃-C₆ heterocycloalkyl, aryl, and heteroaryl, wherein:
   each C₁-C₆ alkyl is optionally substituted with 1-3 R^{E} independently selected from C₃-C₆ cycloalkyl, C₃-C₆ heterocycloalkyl, aryl, and heteroaryl; and
   optionally, one or more instances of R^{D} are taken together with the nitrogen atom to which they are attached to form a C₃-C₆ heterocycloalkyl.

Embodiment 34 is the composition of embodiment 32 or embodiment 33, wherein R^{H} is a saturated, unsubstituted side chain.

Embodiment 35 is the composition of any of embodiments 1-31, wherein each of the one or more salts present in the composition independently comprises a compound of Formula IIA:

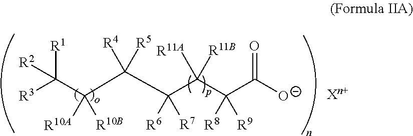

wherein:
R¹, R², R³, R⁴, R⁵, R⁶, R⁷, R⁸, and R⁹ are each independently selected from H, OH, C₁-C₆ alkyl, C₂-C₆ alkenyl, and C₁-C₆ alkoxy;
each occurrence of R^{10A}, R^{10B}, R^{11A}, and R^{11B} is independently selected from H, OH, C₁-C₆ alkyl, C₂-C₆ alkenyl, and C₁-C₆ alkoxy;
any two of R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycloalkyl, or a C₃-C₆ cycloalkyl;
o is an integer from 0 to 17;
p is an integer from 0 to 17;
the sum of o and p is from 0 to 17; and
Xⁿ⁺ is a cationic moiety having formal charge n.

Embodiment 36 is the composition of embodiment 35, wherein:
Xⁿ⁺ is selected from Li⁺, Na⁺, K⁺, Cs⁺, Ag⁺, Ca²⁺, Mg²⁺, Zn²⁺, Cu²⁺, and (R^{D})₄N⁺; and each occurrence of R^{D} is selected from H, C₁-C₆ alkyl, C₃-C₆ cycloalkyl, C₃-C₆ heterocycloalkyl, aryl, and heteroaryl, wherein:
   each C₁-C₆ alkyl is optionally substituted with 1-3 R^{E} independently selected from C₃-C₆ cycloalkyl, C₃-C₆ heterocycloalkyl, aryl, and heteroaryl; and
   optionally, one or more instances of R^{D} are taken together with the nitrogen atom to which they are attached to form a C₃-C₆ heterocycloalkyl.

Embodiment 37 is the composition of any of embodiments 7-36, wherein each of the one or more monoglycerides independently comprises a compound of Formula I-i or Formula I-ii:

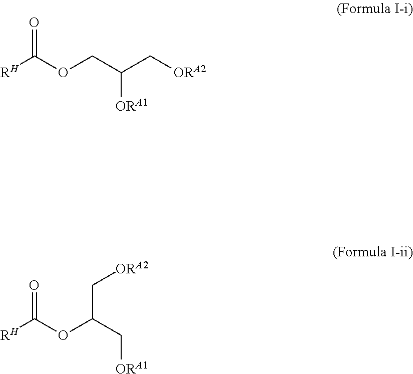

wherein:
R^{A1} and R^{A2} are each independently selected from H and C₁-C₆ alkyl; and
R^{H} is a C₃-C₂₇ side chain.

Embodiment 38 is the composition of embodiment 37, wherein R^{A1} and R^{A2} are each H.

Embodiment 39 is the composition of embodiment 37 or embodiment 38, wherein R^{H} is a saturated, unsubstituted side chain.

Embodiment 40 is the composition of any of embodiments 37-39, wherein R^{H} is a C₁₁-C₂₁ side chain.

Embodiment 41 is the composition of any of embodiments 37-40, wherein the one or more monoglycerides comprise:
a first compound of Formula I-i or Formula I-ii, wherein R^{H} is a C₁₅-C₂₇ side chain; and
a second compound of Formula I-i or Formula I-ii, wherein R^{H} is a C₃-C₁₃ side chain.

Embodiment 42 is the composition of embodiment 41, wherein the second compound of Formula I-i or Formula I-ii is present in a total amount of about 0.5 wt % to about 15 wt % of the composition.

Embodiment 43 is the composition of any of embodiments 7-36, wherein each of the one or more monoglycerides independently comprises a compound of Formula IA-i or Formula IA-ii:

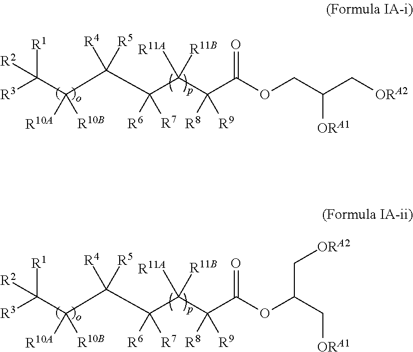

wherein:
R^{A1} and R^{A2} are each independently selected from H and C₁-C₆ alkyl;
R¹, R², R³, R⁴, R⁵, R⁶, R⁷, R⁸, and R⁹ are each independently selected from H, OH, C₁-C₆ alkyl, C₂-C₆ alkenyl, and C₁-C₆ alkoxy;
each occurrence of R^{10A}, R^{10B}, R^{11A}, and R^{11B} is independently selected from H, OH, C₁-C₆ alkyl, C₂-C₆ alkenyl, and C₁-C₆ alkoxy;
any two of R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycloalkyl, or a C₃-C₆ cycloalkyl;
o is an integer from 0 to 17;
p is an integer from 0 to 17; and
the sum of o and p is from 0 to 17.

Embodiment 44 is the composition of embodiment 43, wherein R^{A1} and R^{A2} are each H.

Embodiment 45 is a mixture comprising:
the composition of any of embodiments 1-44; and
a solvent.

Embodiment 46 is the mixture of embodiment 45, wherein the mixture comprises about 30 wt % to about 99.9 wt % of the solvent.

Embodiment 47 is the mixture of embodiment 45, wherein the mixture comprises about 90 wt % to about 99.5 wt % of the solvent.

Embodiment 48 is the mixture of any of embodiments 45-47, wherein the solvent comprises one or more of water, methanol, ethanol, isopropanol, butanol, acetone, ethyl acetate, chloroform, acetonitrile, tetrahydrofuran, diethyl ether, and methyl tert-butyl ether.

Embodiment 49 is a coated agricultural product comprising an agricultural product and a layer disposed on a surface of the agricultural product, wherein the layer comprises the composition of any of embodiments 1-44.

Embodiment 50 is the coated agricultural product of embodiment 49, wherein the layer is disposed on a cuticular surface of the agricultural product.

Embodiment 51 is the coated agricultural product of embodiment 49 or embodiment 50, wherein a thickness of the layer is about 0.1 μm to about 20 μm.

Embodiment 52 is the coated agricultural product of embodiment 49 or embodiment 50, wherein a thickness of the layer is about 0.1 μm to about 10 μm.

Embodiment 53 is a method of coating an agricultural product, the method comprising:
contacting a surface of the agricultural product with a mixture comprising a coating agent and a solvent, wherein the coating agent comprises:
   a wax, present in an amount of about 20 wt % to about 98 wt % of the coating agent; and
   one or more salts of a C₄-C₂₈ fatty acid, present in a total amount of about 2 wt % to about 40 wt % of the coating agent; and
removing at least a portion of the solvent to form a coating on the surface of the agricultural product.

Embodiment 54 is the method of embodiment 53, wherein the wax comprises beeswax, carnauba wax, candelilla wax, sunflower wax, or any combination thereof.

Embodiment 55 is the method of embodiment 53 or embodiment 54, wherein the wax comprises one or more wax esters, present in a total amount of about 50 wt % to about 100 wt % of the wax.

Embodiment 56 is the method of any of embodiments 53-55, wherein:
the wax is present in an amount of about 75 wt % to about 98 wt % of the coating agent; and
the one or more salts are present in an amount of about 2 wt % to about 25 wt % of the coating agent.

Embodiment 57 is the method of any of embodiments 53-56, wherein the coating agent further comprises one or more monoglycerides of a C₄-C₂₈ fatty acid.

Embodiment 58 is the method of embodiment 57, wherein the one or more monoglycerides are present in a total about of about 1 wt % to about 20 wt % of the coating agent.

Embodiment 59 is the method of embodiment 57, wherein:
the wax is present in an amount of about 58 wt % to about 75 wt % of the coating agent;
the one or more salts are present in a total amount of about 2 wt % to about 25 wt % of the coating agent; and
the one or more monoglycerides are present in a total amount of about 10 wt % to about 40 wt % of the coating agent.

Embodiment 60 is the method of embodiment 57, wherein:
the wax is present in an amount of about 35 wt % to about 60 wt % of the coating agent;
the one or more salts are present in a total amount of about 10 wt % to about 30 wt % of the coating agent; and
the one or more monoglycerides are present in a total amount of about 15 wt % to about 35 wt % of the coating agent.

Embodiment 61 is the method of any of embodiments 53-60, wherein a concentration of the coating agent in the mixture is about 1 mg/mL to about 200 mg/mL.

Embodiment 62 is the method of any of embodiments 53-60, wherein a concentration of the coating agent in the mixture is about 25 mg/mL to about 150 mg/mL.

Embodiment 63 is the method of any of embodiments 53-62, wherein the solvent comprises one or more of water, methanol, ethanol, isopropanol, butanol, acetone, ethyl acetate, chloroform, acetonitrile, tetrahydrofuran, diethyl ether, and methyl tert-butyl ether.

Embodiment 64 is the method of any of embodiments 53-63, wherein the coating agent and the solvent make up at least about 98 wt % of the mixture.

Embodiment 65 is the method of any of embodiments 53-64, wherein the surface is a cuticular surface of the agricultural product.

Embodiment 66 is the method of any of embodiments 53-65, wherein contacting the surface comprises:
spraying the mixture onto the surface; or
immersing the agricultural product in the mixture.

Embodiment 67 is the method of any of embodiments 53-66, wherein removing at least a portion of the solvent comprises evaporating at least a portion of the solvent.

Embodiment 68 is the method of any of embodiments 53-67, further comprising adding the coating agent to the solvent to form the mixture.

Embodiment 69 is a method of coating an agricultural product, the method comprising:
contacting a surface of the agricultural product with the mixture of any of embodiments 45-48; and
removing at least a portion of the solvent to form a coating on the surface of the agricultural product.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIGS. 1A and 1B are images of avocados coated with certain coating agents described herein.

FIG. 2 shows the initial design space for a scheffe cubic mixture design of experiment (DoE) for certain compositions described herein.

FIG. 3 is a result profile for phase separation from a scheffe cubic mixture DoE described herein.

FIG. 4 is a ternary plot of gloss level results for a scheffe cubic mixture DoE described herein.

FIGS. 5A-5D show images of slides coated with certain coating agents described herein.

FIG. 6 is an image comparing untreated avocados (left) with avocados coated with a coating agent (right) described herein.

FIG. 7 is an image comparing avocados coated with certain coating agents described herein.

FIG. 8 is an image comparing avocados coated with certain coating agents described herein.

FIG. 9 is a scanning electron microscope (SEM) image of the surface of an untreated avocado.

FIG. 10 is an SEM image of the surface of an avocado coated with a coating agent described herein.

FIG. 11 is an SEM image of the surface of an avocado coated with a coating agent described herein.

FIG. 12 is an SEM image of the surface of an avocado coated with a coating agent described herein.

### DETAILED DESCRIPTION

The present disclosure relates to compositions that can be coated onto an agricultural product to provide an effective barrier, e.g., to gas or water, having particular aesthetic properties. For example, compositions described herein can yield high-, medium-, and low-gloss coatings without deleteriously affecting the barrier properties thereof. The compositions described herein include a wax and a salt of a fatty acid. In some embodiments, the compositions further include a monoglyceride of a fatty acid.

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

### Definitions

The terms “a,” “an,” and “the” are used herein to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

As used herein, the term “about” allows for a degree of variability in a value or range within 10% of a stated value or of a stated limit of a range.

In the methods described herein, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

As used herein, the term “monoglyceride” refers to the condensation product of one glycerol molecule and one fatty acid—that is, a glycerol group attached through an ester linkage to one fatty acid. Monoglycerides can, but need not necessarily be derived from a condensation reaction. For example, monoglycerides can be obtained by an esterification reaction between glycerol and a fatty acid, by transesterification of a triglyceride with glycerol (glycerolysis), etc. Monoglycerides can also be referred to as glyceryl monoalkanoates. Where the glycerol group is attached to the ester linkage at the 1-position (e.g., as in 2,3-dihydroxypropan-1-yl octadecanoate), the monoglyceride can be referred to as a 1-monoglyceride or a 1-glyceryl alkanoate (e.g., as in 1-glyceryl octadecanoate). Where the glycerol group is attached to the ester linkage at the 2-position (e.g., as in 1,3-dihydroxypropan-2-yl hexadecanoate), the monoglyceride can be referred to as a 2-monoglyceride or a 2-glyceryl alkanoate (e.g., as in 2-glyceryl hexadecanoate). The glycerol group of a monoglyceride can be unsubstituted (e.g., as in a 2,3-dihyrdroxpropan-1-yl alkanoate), or can be further substituted with one or more groups other than a fatty acid (e.g., as in a 1,3-dialkoxypropan-2-yl alkanoate).

As used herein, the term “fatty acid” refers to carboxylic acids having an aliphatic side chain. Fatty acids can be naturally or non-naturally occurring, and can include a side chain that is branched or unbranched (e.g., linear), substituted or unsubstituted, and saturated or unsaturated.

As used herein, the term “side chain” refers to the aliphatic portion of a fatty acid, or a portion thereof. Unless otherwise indicated, the side chain of a given fatty acid includes the carbon of the carboxylic acid group. For example, dodecanoic acid can be described as including a linear, saturated C₁₂ side chain, and can also be represented as R^{H}—C(O)OH, where R^{H} is a linear, saturated C₁₁ side chain. Side chains can be present in compounds other than fatty acids, such as, for example, esters or amides, and can, but need not necessarily be derived from a fatty acid. For example, dodecanamide can be described as an amide of a fatty acid, whether or not the compound was in fact derived from dodecanoic acid.

The term “salt,” used in reference to a disclosed compound (e.g., a fatty acid) refers to derivatives of the compound where the parent compound is modified by converting acid or base moieties to their salt form. Examples of such salts include, but are not limited to, mineral or organic acid salts of basic residues such as amine, inorganic (e.g., alkali) or organic salts of acidic residues such as carboxylic acids, and the like.

Where certain features of the compounds described herein are disclosed in groups or in ranges, such disclosure includes each and every individual sub-combination of the members of such groups and ranges. For example, the term “C₁-C₆ alkyl” includes (without limitation) methyl, ethyl, C₃ alkyl, C₄ alkyl, C₅ alkyl, and C₆ alkyl.

As used herein, the term “n-membered,” where n is an integer, typically describes the number of ring-forming atoms in a moiety where the number of ring-forming atoms is n. For example, piperidinyl is an example of a 6-membered heterocycloalkyl ring, and 1,2,3,4-tetrahydro-naphthalene is an example of a 10-membered cycloalkyl group.

As used herein, the term “substituted” means that an atom or group of atoms formally replaces hydrogen as a “substituent” attached to another group. “Substituted,” unless otherwise indicated, refers to any level of substitution, e.g., mono-, di-, tri-, tetra- or penta-substitution, where such substitution is permitted. The substituents are independently selected, and substitution may be at any chemically accessible position. Substitution at a given atom is limited by valency. Substitution at a given atom results in a chemically stable molecule. The phrase “optionally substituted” means unsubstituted or substituted. A single divalent substituent, e.g., oxo, can replace two hydrogen atoms.

As used herein, the term “Cₙ-Cₘ” indicates a range which includes the endpoints, wherein n and m are integers and indicate the number of carbons. Examples include C₁-C₄, C₁-C₆ and the like.

As used herein, the term “alkyl” refers to a saturated hydrocarbon group that may be straight-chained or branched. The term “Cₙ-Cₘ alkyl” refers to an alkyl group having n to m carbon atoms. An alkyl group formally corresponds to an alkane with one C—H bond replaced by the point of attachment of the alkyl group to the remainder of the compound. Examples of alkyl moieties include, but are not limited to, chemical groups such as methyl, ethyl, n-propyl, isopropyl, n-butyl, tert-butyl, isobutyl, sec-butyl; higher homologs such as 2-methyl-1-butyl, n-pentyl, 3-pentyl, n-hexyl, 1,2,2-trimethylpropyl, and the like.

As used herein, the term “alkenyl” refers to a straight-chain or branched hydrocarbon group corresponding to an alkyl group having one or more double carbon-carbon bonds. An alkenyl group formally corresponds to an alkene with one C—H bond replaced by the point of attachment of the alkenyl group to the remainder of the compound. The term “Cₙ—Cₘ alkenyl” refers to an alkenyl group having n to m carbons. Example alkenyl groups include, but are not limited to, ethenyl, n-propenyl, isopropenyl, n-butenyl, sec-butenyl and the like.

As used herein, the term “alkoxy” refers to a group of formula —O-alkyl, wherein the alkyl group is as defined above. The term “Cₙ-Cₘ alkoxy” refers to an alkoxy group, the alkyl group of which has n to m carbons. Example alkoxy groups include methoxy, ethoxy, propoxy (e.g., n-propoxy and isopropoxy), 1-butoxy and the like.

As used herein, the term “cycloalkyl” refers to a non-aromatic hydrocarbon ring system (monocyclic, bicyclic, or polycyclic), including cyclized alkyl and alkenyl groups. The term “Cₙ-Cₘ cycloalkyl” refers to a cycloalkyl that has n to m ring member carbon atoms. Cycloalkyl groups can include fused, bridged, and/or spiro bicyclic or polycyclic ring systems. Examples of cycloalkyl groups include, but are not limited to, cyclopropyl, cyclobutyl, cyclopentyl, cyclohexyl, cycloheptyl, cyclopentenyl, cyclohexenyl, cyclohexadienyl, cycloheptatrienyl, norbornyl, norpinyl, norcarnyl, bicyclo[1.1.0]butanyl, bicyclo[1.1.1 ]pentanyl, bicyclo[2.1.0]pentanyl, bicyclo[2.2.0]hexanyl, bicyclo[3.1.0]hexanyl, bicyclo[3.2.0]heptanyl, and bicyclo[3.3.0]- octanyl, bicyclo[2.1.1]hexanyl, bicyclo[2.2.1 ]heptanyl and bicyclo[1.1. 1 ]pentanyl, and the like.

As used herein, the term “heterocycloalkyl” refers to a non-aromatic ring system (monocyclic, bicyclic, or polycyclic), which may optionally contain one or more alkenylene groups as part of the ring structure, which has at least one heteroatom ring member independently selected from nitrogen, sulfur, oxygen, and phosphorus. The term “n- to m-membered ring heterocycloalkyl” refers to a heterocycloalkyl that has n to m ring-forming atoms. Ring-forming carbon atoms and heteroatoms of a heterocycloalkyl group can be optionally oxidized to form an oxo or sulfido group or other oxidized linkage (e.g., C(O), S(O), C(S), S(O)₂, N-oxide, etc.) or a nitrogen atom can be quaternized. The heterocycloalkyl group can be attached through a ring-forming carbon atom or a ring-forming heteroatom. Heterocycloalkyl groups can include double bonds, for example, up to 3 double bonds. Examples of heterocycloalkyl groups include, but are not limited to, azetidinyl, dihydrofuranyl, dihydrothiophenyl, tetrahydrothiophenyl, tetrahydrofuranyl, tetrahydrotriazinyl, tetrahydropyrazolyl, tetrahydrooxazinyl, tetrahydropyrimidinyl, octahydrobenzofuranyl, octahydrobenzimidazolyl, octahydrobenzothiazolyl, imidazolidinyl, pyrrolidinyl, piperidinyl, piperazinyl, oxazolidinyl, thiazolidinyl, pyrazolidinyl, thiomorpholinyl, tetrahydropyranyl, tetrahydrothiazinyl, tetrahydrothiadiazinyl, tetrahydro-oxazolyl, morpholinyl, oxetanyl, dioxetanyl, dioxolanyl, dioxanyl, oxapanyl, dioxapanyl, oxacanyl, dioxacanyl, tetrahydrodiazinyl, oxazinyl, oxathiazinyl, quinuclidinyl, chromanyl, isochromanyl, dihydrobenzodioxinyl, benzodioxolyl, benzoxazinyl, indolinyl, dihydrobenzofuranyl, tetrahydroquinolyl, isochromyl, dihydro-1H-isoindolyl, 2-azabicyclo[2.2.1 ]heptanonyl, 3-azabicyclo[3.1.0]hexanyl, 3-azabicyclo[4.1.0]heptanyl, and the like. Further examples of heterocycloalkyl groups include tetrahydrofuran-2-yl, tetrahydrofuran-3-yl, imidazolidin-1-yl, imidazolidin-2-yl, imidazolidin-4-yl, pyrrolidin-1-yl, pyrrolidin-2-yl, pyrrolidin-3-yl, piperidin-1-yl, piperidin-2-yl, piperidin-3-yl, piperidin-4-yl, piperazin-1-yl, piperazin-2-yl, 1,3-oxazolidin-3-yl, 1,4-oxazepan-1-yl, isothiazolidinyl, 1,3-thiazolidin-3-yl, 1,2-pyrazolidin-2-yl, 1,2-tetrahydrothiazin-2-yl, 1,3-thiazinan-3-yl, 1,2-tetrahydrodiazin-2-yl, 1,3-tetrahydrodiazin-1-yl, 1,4-oxazin-4-yl, oxazolidinonyl, 2-oxo-piperidinyl (e.g., 2-oxo-piperidin-1-yl), and the like.

### Compositions

Provided herein are compositions including a wax and one or more salts of a C₄-C₂₈ fatty acid. In some embodiments, the wax is present in an amount of about 20 wt % to about 98 wt % of the composition, for example, about 20 wt % to about 75 wt %, about 20 wt % to about 60 wt %, about 35 wt % to about 98 wt %, about 35 wt % to about 75 wt %, about 35 wt % to about 60 wt %, about 40 wt % to about 98 wt %, about 40 wt % to about 75 wt %, about 40 wt % to about 60 wt %, about 58 wt % to about 98 wt %, about 58 wt % to about 75 wt %, about 60 wt % to about 98 wt %, about 60 wt % to about 75 wt %, or about 75 wt % to about 98 wt % of the composition.

In some embodiments, the one or more salts are present in a total amount of about 2 wt % to about 40 wt % of the composition, for example, about 2 wt % to about 30 wt %, about 2 wt % to about 25 wt %, about 2 wt % to about 15 wt %, about 5 wt % to about 40 wt %, about 5 wt % to about 30 wt %, about 5 wt % to about 25 wt %, about 5 wt % to about 15 wt %, about 10 wt % to about 40 wt %, about 10 wt % to about 30 wt %, about 10 wt % to about 25 wt %, or about 10 wt % to about 15 wt % of the composition. In some embodiments, a ratio of a total mass of the wax to a total mass of the one or more salts is about 50:1 to about 3:1, about 40:1 to about 2:1, or about 6:1 to about 1:1. In some embodiments, the wax and the one or more salts are present in an amount of at least about 80 wt % of the composition, for example, at least about 85 wt %, at least about 90 wt %, at least about 95 wt %, at least about 97.5 wt %, at least about 98 wt %, or at least about 99 wt % of the composition.

In some embodiments, the composition further includes one or more monoglycerides of a C₄-C₂₈ fatty acid. In some embodiments, the one or more monoglycerides are present in an amount of about 1 wt % to about 45 wt % of the composition, for example, about 1 wt % to about 40 wt %, about 1 wt % to about 35 wt %, about 1 wt % to about 26 wt %, about 1 wt % to about 20 wt %, about 10 wt % to about 45 wt %, about 10 wt % to about 40 wt %, about 10 wt % to about 35 wt %, about 10 wt % to about 26 wt %, about 10 wt % to about 20 wt %, about 15 wt % to about 45 wt %, about 15 wt % to about 40 wt %, about 15 wt % to about 35 wt %, about 15 wt % to about 26 wt %, or about 15 wt % to about 20 wt % of the composition. In some embodiments, a ratio of the total mass of the wax to a total mass of the one or more monoglycerides is about 100:1 to about 3:1, about 8:1 to about 1:1, or about 4:1 to about 1:1. In some embodiments, the wax, the one or more salts, and the one or more monoglycerides are present in an amount of at least about 80 wt % of the composition, for example, at least about 85 wt %, at least about 90 wt %, at least about 95 wt %, at least about 97.5 wt %, at least about 98 wt %, or at least about 99 wt % of the composition.

### Waxes

The compositions described herein include a wax. In some embodiments, the wax includes beeswax, carnauba wax, candelilla wax, sunflower wax, or any combination thereof. In some embodiments, the wax includes a beeswax identified as E901 (authorized food additive) by the European Safety Authority (ESA). In some embodiments, the wax includes a beeswax identified as Chemical Abstract Service (CAS) No. 8006-40-4 or 8012-89-3, each identified by the U.S. Food and Drug Agency (FDA) as generally recognized as safe (GRAS). In some embodiments, the wax includes a carnauba wax identified as E903 (authorized food additive) by the ESA. In some embodiments, the wax includes a carnauba wax identified as CAS No. 008-015-869, identified by the FDA as GRAS. In some embodiments, the wax includes a candelilla wax identified as E902 (authorized food additive) by the ESA. In some embodiments, the wax includes a candelilla wax identified as CAS No. 8006-44-8, identified by the FDA as GRAS. In some embodiments, the wax includes a sunflower wax identified as CAS No. 1286686-34-7.

In some embodiments, the wax includes one or more wax esters. In some embodiments, the wax esters include one or more of mono-, di-, and triesters formed from C₁₂-C₂₀ fatty acids and/or C₁₂-C₂₀ hydroxy fatty acids, and C₂₄-C₃₂ alcohols and/or diols. In some embodiments, one or more of the wax esters independently includes a compound of Formula III:

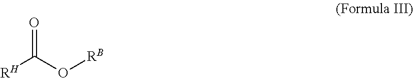

wherein:
each R^{B} is
   C₂₄-C₃₂ alkyl or C₂₄-C₃₂ alkenyl, each optionally substituted with 1-3 R^{C}, or

—R^{H}C(O)OR^{D};
each R^{C} is independently —OH, —C(O)OR^{D}, or —OC(O)R^{H};
each R^{D} is H or R^{B}, and
each R^{H} is independently a C₁₁-C₁₉ side chain optionally substituted with 1-3 R^{C}.

In some embodiments of Formula III, R^{B} is unsubstituted. In some embodiments of Formula III, one or more R^{B} is C₂₄-C₃₂ alkyl, for example, C₃₀ or C₃₂ alkyl. In some embodiments of Formula III, R^{H} is unsubstituted. In some embodiments of Formula III, one or more R^{H} is a C₁₃ or C₁₅ side chain. In some embodiments of Formula III, each R^{H} is a saturated side chain.

In some embodiments, the one or more wax esters include one or more monoesters. In certain such embodiments, the one or more monoesters are present in a total amount of about 40 wt % to about 100 wt % of the one or more wax esters. In some embodiments, the one or more wax esters include one or more diesters. In certain such embodiments, the one or more diesters are present in a total amount of about 5 wt % to about 50 wt % of the one or more wax esters. In some embodiments, the one or more wax esters include one or more triesters. In certain such embodiments, the one or more triesters are present in a total amount of about 0.5 wt % to about 15 wt % of the one or more wax esters. In some embodiments, the one or more wax esters make up about 50 wt % to about 100 wt % of the wax, for example, about 60 wt % to about 100 wt %, or about 70 wt % to about 100 wt % of the wax.

In some embodiments, the wax includes one or more alkanes. For example, in certain such embodiments, the wax includes one or more C₂₄-C₃₆ alkanes. In some embodiments, the one or more wax esters and the one or more C₂₄-C₃₆ alkanes make up about 60 wt % to about 100 wt % of the wax, for example, about 70 wt % to about 100 wt %, or about 80 wt % to about 100 wt % of the wax.

In some embodiments, the wax includes one or more diesters of p-methoxy- and/or p-hydroxycinnamic acid. In some embodiments, the wax includes one or more compounds of Formula IV:

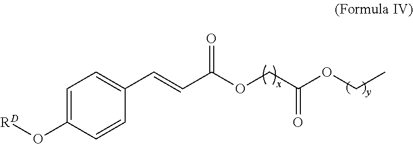

wherein:
R^{D} is H or C₁ alkyl; and
the sum of x and y is from 28 to 88.

In some embodiments, the sum of x and y is from 38 to 88, from 28 to 78, or from 38 to 78. In some embodiments, the one or more wax esters and the one or more compounds of Formula IV make up about 60 wt % to about 100 wt %, for example, about 70 wt % to about 100 wt %, or about 80 wt % to about 100 wt % of the wax.

Salts of a C₄-C₂₈ Fatty Acid

In some embodiments, the composition includes one salt of a C₄-C₂₈ fatty acid. In some embodiments, the composition includes two, three, or more salts of a C₄-C₂₈ fatty acid, for example, two salts of a C₄-C₂₈ fatty acid. In some embodiments, the salts include one or more salts of a naturally occurring fatty acid.

In some embodiments, the salts include one or more salts of a C₆-C₂₈ fatty acid, a C₈-C₂₈ fatty acid, a C₄-C₂₄ fatty acid, a C₆-C₂₄ fatty acid, a C₁₂-C₂₄ fatty acid, a C₄-C₂₂ fatty acid, a C₆-C₂₂ fatty acid, or a C₁₂-C₂₂ fatty acid. In some embodiments, the salts include two salts of a C₁₂-C₂₂ fatty acid, for example, a salt of a C₁₆ fatty acid and a Cis fatty acid. In some embodiments, one or more of the salts include an unsubstituted side chain, for example, an unsubstituted C₁₂-C₂₂ side chain. In some embodiments, one or more of the salts include a linear side chain, for example, a linear C₁₂-C₂₂ side chain. In some embodiments, one or more of the salts include a saturated side chain, for example, a saturated C₁₂-C₂₂ side chain.

In some embodiments, the salts include one or more compounds of Formula II:

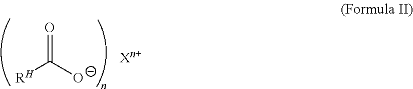

wherein:
R^{H} is a C₃-C₂₇ side chain; and
Xⁿ⁺ is a cationic moiety having formal charge n.

In some embodiments, each of the one or more salts independently includes a compound of Formula II. In some embodiments of Formula II, Xⁿ⁺ is selected from Li⁺, Na⁺, K⁺, Cs⁺ Ag⁺, Ca²⁺, Mg²⁺, Zn²⁺, Cu²⁺, and (R^{D})₄N⁺, where each occurrence of R^{D} is selected from H, C₁-C₆ alkyl, C₃-C₆ cycloalkyl, C₃-C₆ heterocycloalkyl, aryl, and heteroaryl, and where each C₁-C₆ alkyl is optionally substituted with 1-3 R^{E} independently selected from C₃-C₆ cycloalkyl, C₃-C₆ heterocycloalkyl, aryl, and heteroaryl. In some embodiments, Xⁿ⁺ is (R^{D})₄N⁺, and one or more instances of R^{D} are taken together with the nitrogen atom to which they are attached to form a C₃-C₆ heterocycloalkyl. In some embodiments of Formula II, Xⁿ⁺ is selected from Na⁺, K⁺, Ca²⁺, Mg²⁺, and Zn²⁺. In some embodiments of Formula II, R^{H} is a saturated side chain. In some embodiments of Formula II, R^{H} is an unsubstituted side chain. In some embodiments of Formula II, R^{H} is a linear side chain. In some embodiments of Formula II, R^{H} is a C₅-C₁₇ side chain. In some embodiments of Formula II, R^{H} is a C₁₁-C₂₁ side chain.

In some embodiments, the salts include one or more compounds of Formula IIA:

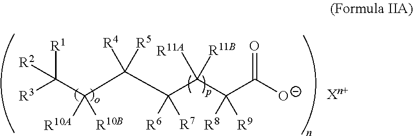

wherein:
R¹, R², R³, R⁴, R⁵, R⁶, R⁷, R⁸, and R⁹ are each independently selected from H, OH, C₁-C₆ alkyl, C₂-C₆ alkenyl, and C₁-C₆ alkoxy;
each occurrence of R^{10A}, R^{10B}, R^{11A}, and R^{11B} is independently selected from H, OH, C₁-C₆ alkyl, C₂-C₆ alkenyl, and C₁-C₆ alkoxy;
any two of R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycloalkyl, or a C₃-C₆ cycloalkyl;
o is an integer from 0 to 17;
p is an integer from 0 to 17;
the sum of o and p is from 0 to 17; and
Xⁿ⁺ is a cationic moiety having formal charge n.

In some embodiments, each of the one or more salts independently includes a compound of Formula IIA. In some embodiments of Formula IIA, Xⁿ⁺ is selected from Li⁺, Na⁺, K⁺, Cs⁺, Ag⁺, Ca²⁺, Mg²⁺, Zn²⁺, Cu²⁺, and (R^{D})₄N⁺, where each occurrence of R^{D} is selected from H, C₁-C₆ alkyl, C₃-C₆ cycloalkyl, C₃-C₆ heterocycloalkyl, aryl, and heteroaryl, and where each C₁-C₆ alkyl is optionally substituted with 1-3 R^{E} independently selected from C₃-C₆ cycloalkyl, C₃-C₆ heterocycloalkyl, aryl, and heteroaryl. In some embodiments, Xⁿ⁺ is (R^{D})₄N⁺, and one or more instances of R^{D} are taken together with the nitrogen atom to which they are attached to form a C₃-C₆ heterocycloalkyl. In some embodiments of Formula II, Xⁿ⁺ is selected from Na⁺, K⁺, Ca²⁺, Mg²⁺, and Zn²⁺.

In some embodiments of Formula IIA, each of R¹, R², R³, R⁴, R⁵, R⁶, R⁷, R⁸, and R⁹, and each occurrence of R^{10A}, R^{10B}, R^{11A}, and R^{11B} are independently selected from H and OH. In some embodiments of Formula IIA, any two of R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form an oxirane. In some embodiments of Formula IIA, two pairs, one pair, or none of R¹, R², R³, R⁴, R⁵, R⁶, R⁷, R⁸, and R⁹, and each occurrence of R^{10A}, R^{10B}, R^{11A}, and R^{11B} on adjacent carbon atoms are taken together with the carbon atoms to which they are attached to form a double bond. In some embodiments of Formula IIA, one pair, or none of R¹, R², R³, R⁴, R⁵, R⁶, R⁷, R⁸, and R⁹, and each occurrence of R^{10A}, R^{10B}, R^{11A}, and R^{11B} on adjacent carbon atoms are taken together with the carbon atoms to which they are attached to form an oxirane. In some embodiments of Formula IIA, two, one, or none of R¹, R², R³, R⁴, R⁵, R⁶, R⁷, R⁸, and R⁹, and each occurrence of R^{10A}, R^{10B}, R^{11A}, and R^{11B} are OH.

In some embodiments of Formula IIA, the sum of o and p is from 0 to 13, from 0 to 11, from 0 to 9, from 0 to 7, from 5 to 17, from 5 to 13, from 5 to 11, from 5 to 9, from 5 to 7, from 7 to 17, from 7 to 13, from 7 to 11, from 7 to 9, from 9 to 17, from 9 to 13, from 9 to 11, from 11 to 17, or from 11 to 13.

In some embodiments, the salts include one or more salts, for example, sodium, potassium, silver, calcium, magnesium or zinc salts, of a saturated, linear, unsubstituted fatty acid. In some embodiments, the salts include one or more salts, for example, sodium, potassium, silver, calcium, magnesium or zinc salts, of heptanoic acid, octanoic acid, nonanoic acid, decanoic acid, undecanoic acid, dodecanoic acid, tridecanoic, tetradecanoic acid, pentadecanoic acid, hexadecanoic acid, heptadecanoic acid, octadecanoic acid, nonadecanoic acid, eicosanoic acid, heneicosanoic acid or docosanoic acid.

Monoglycerides of a C₄-C₂₈ Fatty Acid

The compositions described herein can include one or more monoglycerides of a C₄-C₂₈ fatty acid. In some embodiments, the composition includes one monoglyceride of a C₄-C₂₈ fatty acid. In some embodiments, the composition includes two, three, or more monoglycerides of a C₄-C₂₈ fatty acid, for example, two monoglycerides of a C₄-C₂₈ fatty acid. In some embodiments, the monoglycerides include one or more monoglycerides of a naturally occurring fatty acid.

The monoglycerides can include one or more 1-monoglycerides, one or more 2-monoglycerides, or a mixture thereof. In some embodiments, the monoglycerides include one or more 2,3-dihydroxypropan-1-yl esters of a fatty acid, one or more 1,3-dihydroxypropan-2-yl esters of a fatty acid, or a mixture thereof. In some embodiments, 1-monoglycerides make up at least about 50 wt %, at least about 70 wt %, at least about 80 wt %, at least about 90 wt %, or about 100 wt % of the monoglycerides present in the composition. In some embodiments, 1-monoglycerides make up about 70 wt % to about 100 wt %, about 70 wt % to about 90 wt %, about 75 wt % to about 100 wt %, about 75 wt % to about 90 wt %, about 80 wt % to about 100 wt %, or about 80 wt % to about 90 wt % of the monoglycerides present in the composition.

In some embodiments, the monoglycerides include one or more monoglycerides of a C₆-C₂₈ fatty acid, a C₈-C₂₈ fatty acid, a C₄-C₂₄ fatty acid, a C₆-C₂₄ fatty acid, a C₁₂-C₂₄ fatty acid, a C₄-C₂₂ fatty acid, a C₆-C₂₂ fatty acid, or a C₁₂-C₂₂ fatty acid. In some embodiments, one or more of the monoglycerides include an unsubstituted side chain, for example, an unsubstituted C₁₂-C₂₂ side chain. In some embodiments, one or more of the monoglycerides include a linear side chain, for example, a linear C₁₂-C₂₂ side chain. In some embodiments, one or more of the monoglycerides include a saturated side chain, for example, a saturated C₁₂-C₂₂ side chain.

In some embodiments, the monoglycerides include one or more compounds of Formula I-i:

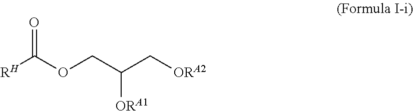

wherein:
R^{A1} and R^{A2} are each independently selected from H and C₁-C₆ alkyl; and
R^{H} is a C₃-C₂₇ side chain.

In some embodiments, the monoglycerides include one or more compounds of Formula I-ii:

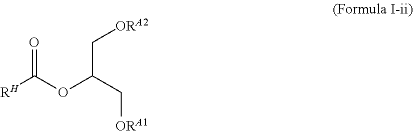

wherein:
R^{A1} and R^{A2} are each independently selected from H and C₁-C₆ alkyl; and
R^{H} is a C₃-C₂₇ side chain.

In some embodiments, each of the one or more monoglycerides independently includes a compound of Formula I-i or Formula I-ii. In some embodiments of Formula I-i or Formula I-ii, R^{A1} and R^{A2} are each H. In some embodiments of Formula I-i or Formula I-ii, R^{H} is a saturated side chain. In some embodiments of Formula I-i or Formula I-ii, R^{H} is an unsubstituted side chain. In some embodiments of Formula I-i or Formula I-ii, R^{H} is a linear side chain. In some embodiments of Formula I-i or Formula I-ii, R^{H} is a C₅-C₁₇ side chain. In some embodiments of Formula I-i or Formula I-ii, R^{H} is a C₁₁-C₂₁ side chain.

In some embodiments, the monoglycerides include a first compound of Formula I-i or Formula I-ii, where R^{H} is a C₁₅-C₂₇ side chain; and a second compound of Formula I-i or Formula I-ii, where R^{H} is a C₃-C₁₃ side chain. In some embodiments, R^{H} of the first compound is a C₁₅-C₂₁ side chain, and R^{H} of the second compound is a C₁-C₁₃ side chain. In some embodiments, the second compound of formula I-i or Formula I-ii is present in a total amount of about 0.5 wt % to about 15 wt % of the composition, for example, about 1 wt % to about 10 wt %, or about 1 wt % to about 5 wt %, about 5 wt % to about 15 wt %, or about 5 wt % to about 10 wt % of the composition.

In some embodiments, the monoglycerides include one or more compounds of Formula IA-i:

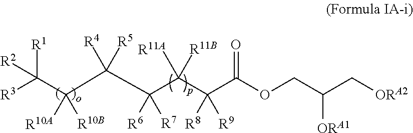

wherein:
R^{A1} and R^{A2} are each independently selected from H and C₁-C₆ alkyl;
R¹, R², R³, R⁴, R⁵, R⁶, R⁷, R⁸, and R⁹ are each independently selected from H, OH, C₁-C₆ alkyl, C₂-C₆ alkenyl, and C₁-C₆ alkoxy;
each occurrence of R^{10A}, R^{10B}, R^{11A}, and R^{11B} is independently selected from H, OH, C₁-C₆ alkyl, C₂-C₆ alkenyl, and C₁-C₆ alkoxy;
any two of R¹, R², R³, R⁴, R³, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycloalkyl, or a C₃-C₆ cycloalkyl;
o is an integer from 0 to 17;
p is an integer from 0 to 17; and
the sum of o and p is from 0 to 17.

In some embodiments, the monoglycerides include one or more compounds of Formula IA-ii:

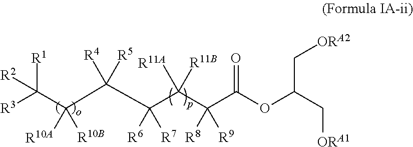

wherein:
R^{A1} and R^{A2} are each independently selected from H and C₁-C₆ alkyl;
R¹, R², R³, R⁴, R⁵, R⁶, R⁷, R⁸, and R⁹ are each independently selected from H, OH, C₁-C₆ alkyl, C₂-C₆ alkenyl, and C₁-C₆ alkoxy;
each occurrence of R^{10A}, R^{10B}, R^{11A}, and R^{11B} is independently selected from H, OH, C₁-C₆ alkyl, C₂-C₆ alkenyl, and C₁-C₆ alkoxy;
any two of R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycloalkyl, or a C₃-C₆ cycloalkyl;
o is an integer from 0 to 17;
p is an integer from 0 to 17; and
the sum of o and p is from 0 to 17.

In some embodiments, each of the one or more monoglycerides independently includes a compound of Formula IA-i or Formula IA-ii. In some embodiments of Formula IA-i or Formula IA-ii, R^{A1} and R^{A2} are each H. In some embodiments of Formula IA-i or Formula IA-ii, each of R¹, R², R³, R⁴, R⁵, R⁶, R⁷, R⁸, and R⁹, and each occurrence of R^{10A}, R^{10B}, R^{11A}, and R^{11B} are independently selected from H and OH. In some embodiments of Formula IA-i or Formula IA-ii, any two of R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form an oxirane. In some embodiments of Formula IA-i or Formula IA-ii, two pairs, one pair, or none of R¹, R², R³, R⁴, R⁵, R⁶, R⁷, R⁸, and R⁹, and each occurrence of R^{10A}, R^{10B}, R^{11A}, and R^{11B} on adjacent carbon atoms are taken together with the carbon atoms to which they are attached to form a double bond. In some embodiments of Formula IA-i or Formula IA-ii, one pair, or none of R¹, R², R³, R⁴, R⁵, R⁶, R⁷, R⁸, and R⁹, and each occurrence of R^{10A}, R^{10B}, R^{11A}, and R^{11B} on adjacent carbon atoms are taken together with the carbon atoms to which they are attached to form an oxirane. In some embodiments of Formula IA-i or Formula IA-ii, two, one, or none of R¹, R², R³, R⁴, R⁵, R⁶, R⁷, R⁸, and R⁹, and each occurrence of R^{10A}, R^{10B}, R^{11A}, and R^{11B} are OH.

In some embodiments of Formula IA-i or Formula IA-ii, the sum of o and p is from 0 to 13, from 0 to 11, from 0 to 9, from 0 to 7, from 5 to 17, from 5 to 13, from 5 to 11, from 5 to 9, from 5 to 7, from 7 to 17, from 7 to 13, from 7 to 11, from 7 to 9, from 9 to 17, from 9 to 13, from 9 to 11, from 11 to 17, or from 11 to 13.

In some embodiments, the monoglycerides include one or more 1-monoglycerides or 2-monoglycerides, for example, 2,3-dihydroxypropan-1-yl esters or 1,3-dihydroxypropan-2-yl esters, of heptanoic acid, octanoic acid, nonanoic acid, decanoic acid, undecanoic acid, dodecanoic acid, tridecanoic, tetradecanoic acid, pentadecanoic acid, hexadecanoic acid, heptadecanoic acid, octadecanoic acid, nonadecanoic acid, eicosanoic acid, heneicosanoic acid, or docosanoic acid.

### Additional Components

The compositions described herein can include one or more additional components, for example, components that are non-toxic and safe for consumption by humans and/or animals. For example, the composition can include direct or indirect food additives or food-contact substances approved by the U.S. Food and Drug Administration (FDA), components satisfying FDA regulatory requirements to be used as a food additive or food contact substance, or components generally recognized as safe (GRAS) by the FDA.

In some embodiments, the compositions described herein further include one or more fatty acids, for example, C₄-C₂₂ fatty acids. In some embodiments, the composition includes less than about 10 wt %, for example, less than about 5 wt %, less than about 2 wt %, less than about 1 wt %, or is free from one or more of triglycerides, diglycerides, acetylated monoglycerides, lactlyated monoglycerides, succinylated monoglycerides, sterols, bile acids, proteins, polysaccharides, phenols, lignans, aromatic acids, terpenoids, flavonoids, carotenoids, alkaloids, alcohols, alkanes, aldehydes, and any salts thereof.

### Mixtures

Also provided herein are mixtures including a composition described herein and a solvent. In some embodiments, the mixture is a colloidal dispersion (e.g., an emulsion) of a composition described herein in a solvent. In some embodiments, the solvent includes water, ammonia, methanol, ethanol, isopropanol, butanol, acetone, ethyl acetate, chloroform, acetonitrile, tetrahydrofuran, diethyl ether, methyl tert-butyl ether, or any combination thereof. In some embodiments, the solvent includes water, ethanol, or a combination thereof. In some embodiments, the solvent includes water and one or more of ammonia, methanol, ethanol, isopropanol, butanol, acetone, ethyl acetate, chloroform, acetonitrile, tetrahydrofuran, diethyl ether, and methyl tert-butyl ether. In some embodiments, the solvent includes water and ammonia.

In some embodiments, the mixture includes about 30 wt % to about 99.9 wt %, about 30 wt % to about 99.5 wt %, about 30 wt % to about 99 wt %, about 50 wt % to about 99.9 wt %, about 50 wt % to about 99.5 wt %, about 50 wt % to about 99 wt %, about 90 wt % to about 99.9 wt %, about 90 wt % to about 99.5 wt %, or about 90 wt % to about 99 wt % of solvent.

In some embodiments, the concentration of the composition in the mixture is about 1 mg/mL to about 200 mg/mL, about 1 mg/mL to about 150 mg/mL, about 1 mg/mL to about 125 mg/mL, about 1 mg/mL to about 100 mg/mL, about 25 mg/mL to about 200 mg/mL, about 25 mg/mL to about 150 mg/mL, about 25 mg/mL to about 125 mg/mL, about 25 mg/mL to about 100 mg/mL, about 50 mg/mL to about 200 mg/mL, about 50 mg/mL to about 150 mg/mL, about 50 mg/mL to about 125 mg/mL, or about 50 mg/mL to about 100 mg/mL.

### Coatings

Also provided herein are coated agricultural products including an agricultural product and a layer formed from a composition or mixture described herein, disposed on a surface of the agricultural product. In some embodiments, the agricultural product is an edible agricultural product including, for example, fruits, vegetables, edible seeds and nuts, herbs, spices, produce, meat, eggs, dairy products, seafood, grains, or any other consumable item. In other embodiments, the agricultural product is an inedible agricultural product including, for example, inedible flowers, seeds, shoots, stems, leaves, whole plants, and the like. In some embodiments, the layer is disposed on an exterior surface (e.g., a cuticular surface) of the agricultural product.

In some embodiments, the layer has a thickness of about 0.1 μm to about 20 μm, for example, about 0.1 μm to about 15 μm, about 0.1 μm to about 10 μm, about 0.5 μm to about 20 um, about 0.5 μm to about 15 μm, about 0.5 μm to about 10 μm, about 1 μm to about 20 μm, about 1 μm to about 15 μm, or about 1 μm to about 10 μm.

### Coating Methods

Also provided herein are methods for coating an agricultural product, the methods including contacting a surface of the agricultural product with a mixture including a coating agent and a solvent, and removing at least a portion of the solvent to form a coating on the surface of the agricultural product. The coating agent includes a wax and one or more salts of a C₄-C₂₈ fatty acid. In some embodiments, the coating agent is a composition described herein. For example, in some embodiments, the coating agent includes about 20 wt % to about 98 wt % of the wax, and about 2 wt % to about 40 wt % of the one or more salts. In some embodiments, the coating agent includes one or more monoglycerides of a C₄-C₂₈ fatty acid. In certain such embodiments, the one or more monoglycerides are present in a total amount of about 1 wt % to about 45 wt % of the coating agent.

In some embodiments of the coating method, the agricultural product is an edible agricultural product including, for example, fruits, vegetables, edible seeds and nuts, herbs, spices, produce, meat, eggs, dairy products, seafood, grains, or any other consumable item. In other embodiments of the coating method, the agricultural product is an inedible agricultural product including, for example, inedible flowers, seeds, shoots, stems, leaves, whole plants, and the like. In some embodiments, the method includes contacting an exterior surface (e.g., a cuticular surface) of the agricultural product with the coating agent-containing mixture.

In some embodiments, the coating agent includes about 75 wt % to about 98 wt % of the wax, about 2 wt % to about 25 wt % of the one or more salts, and, optionally, about 1 wt % to about 20 wt % of the one or more monoglycerides. In some embodiments, the coating agent includes about 58 wt % to about 75 wt % of the wax, about 2 wt % to about 25 wt % of the one or more salts, and about 10 wt % to about 40 wt % of the one or more monoglycerides. In some embodiments, the coating agent includes about 35 wt % to about 60 wt % of the wax, about 10 wt % to about 30 wt % of the one or more salts, and about 15 wt % to about 35 wt % of the one or more monoglycerides.

In some embodiments of the coating method, the wax includes beeswax, carnauba wax, candelilla wax, sunflower wax, or any combination thereof. In some embodiments of the coating method, the wax includes one or more wax esters, e.g., one or more compounds of Formula III described herein, present in a total amount of about 50 wt % to about 100 wt % of the wax. In some embodiments of the coating method, the wax includes one or more compounds of Formula IV described herein. In some embodiments of the coating method, the one or more salts include a compound of Formula II or Formula IIA described herein. In some embodiments, the one or more monoglycerides include a compound of Formula I-i, Formula I-ii, Formula IA-i, or Formula IA-ii described herein.

In some embodiments, the wax and the one or more salts make up at least about 70 wt % of the coating agent, for example, about 80 wt % to about 100 wt %, or about 90 wt % to about 100 wt % of the coating agent. In some embodiments, the coating agent further includes one or more monoglycerides of a C₄-C₂₈ fatty acid, and the wax, the one or more salts, and the one or more monoglycerides make up at least about 80 wt % of the coating agent, for example, about 90 wt % to about 100 wt % of the coating agent, or about 95 wt % to about 100 wt % of the coating agent.

In some embodiments of the coating method, the solvent includes water, methanol, ethanol, isopropanol, butanol, acetone, ethyl acetate, chloroform, acetonitrile, tetrahydrofuran, diethyl ether, methyl tert-butyl ether, or any combination thereof. In some embodiments of the coating method, the solvent includes water, ethanol, or a combination thereof. In some embodiments, the solvent includes water and one or more of ammonia, methanol, ethanol, isopropanol, butanol, acetone, ethyl acetate, chloroform, acetonitrile, tetrahydrofuran, diethyl ether, and methyl tert-butyl ether. In some embodiments, the solvent includes water and ammonia.

In some embodiments of the coating method, the concentration of the coating agent in the mixture is about 1 mg/mL to about 200 mg/mL, about 1 mg/mL to about 150 mg/mL, about 1 mg/mL to about 125 mg/mL, about 1 mg/mL to about 100 mg/mL, about 25 mg/mL to about 200 mg/mL, about 25 mg/mL to about 150 mg/mL, about 25 mg/mL to about 125 mg/mL, about 25 mg/mL to about 100 mg/mL, about 50 mg/mL to about 200 mg/mL, about 50 mg/mL to about 150 mg/mL, about 50 mg/mL to about 125 mg/mL, or about 50 mg/mL to about 100 mg/mL.

In some embodiments of the coating method, contacting the surface of the agricultural product includes spraying the mixture onto the surface of the agricultural product. The mixture can be sprayed, for example, from a commercially available sprayer. In some embodiments, the mixture is aerosol-sprayed onto the surface of the agricultural product. In some embodiments of the coating method, contacting the surface of the agricultural product includes immersing the agricultural product in the mixture. In other embodiments of the coating method, the mixture can be brushed, dripped, drop-cast, rolled, dabbed, or poured on the surface of the agricultural product.

In some embodiments of the coating method, removing at least a portion of the solvent includes evaporating at least a portion of the solvent. In some embodiments, the evaporation can be passive. In other embodiments, the evaporation can be active, for example, as in convective drying.

### EXAMPLES

### Example 1. Coated Apples

Coating agents A and B having the compositions shown in Table 1 were prepared.

TABLE 1
Coating Agents

| | A | B |
|---|---|---|
| Glyceryl | 81.8 wt % | 22.5 wt % |
| Monostearate¹ | | |
| Sodium Stearate | 18.2 wt % | 5 wt % |
| Beeswax² | — | 72.5 wt % |

¹mixture of 2,3-dihydroxypropan-1-yl octadecanoate and 1,3-dihydroxypropan-2-yl octadecanoate (molar ratio of 2,3-dihydroxypropan-1-yl octadecenoate:1,3-dihydroxypropan-2-yl octadecanoate of about 85:15 to about 95:5)
²refined beeswax (Sigma Aldrich 243248; CAS no. 8012-89-3)

Mixtures 1 and 2 of coating agents A and B dispersed in water at the concentrations shown in Table 2 were prepared. For each of mixtures 1 and 2, apples were coated by dipping into a bowl of the mixture and then drying in a heat tunnel at 50-60 ° C. (residence time 90-100 sec). Mass loss of the coated apples and a comparative group of uncoated apples was then measured under ambient conditions. Results are shown in Table 2.

TABLE 2
Mixtures; Mass Loss of Apples

| | | | Mass Loss |
|---|---|---|---|
| | Coating Agent | Concentration | Factor¹ |
| Mixture 1 | A | 11 g/L | 1 |
| Mixture 2 | B | 40 g/L | 1.22 |
| Untreated | — | — | 1 |

¹ratio of the average mass loss rate of untreated control to the average mass loss rate of corresponding tested produce for a given period of time

As shown in Table 2, coatings formed from coating agents including beeswax reduced mass loss from produce.

### Example 2. Coated Avocados

Coating agents C and D having the compositions shown in Table 3 were prepared.

TABLE 3
Coating Agents

| | C | D |
|---|---|---|
| Glyceryl | 22.5 wt % | — |
| Monostearate¹ | | |
| Sodium Stearate | 5 wt % | 5 wt % |
| Beeswax² | 72.5 wt % | 95 wt % |

¹mixture of 2,3-dihydroxypropan-1-yl octadecanoate and 1,3-dihydroxypropan-2-y1 octadecanoate (molar ratio of 2,3-dihydroxypropan-1-yl octadecenoate:1,3-dihydroxypropan-2-yl octadecanoate of about 85:15 to about 95:5)
²refined beeswax (Sigma Aldrich 243248; CAS no. 8012-89-3)

Mixtures 3 and 4 of coating agents C and D dispersed in water at the concentrations shown in Table 4 were prepared. For each of mixtures 3 and 4, avocados were coated by dipping into a bowl of the mixture and then drying in a heat tunnel at about 70° C. (residence time 90-100 sec.). The coated avocados were evaluated under ambient conditions.

TABLE 4
Mixtures

| | Coating Agent | Concentration |
|---|---|---|
| Mixture 3 | C | 30 g/L |
| Mixture 4 | D | 30 g/L |

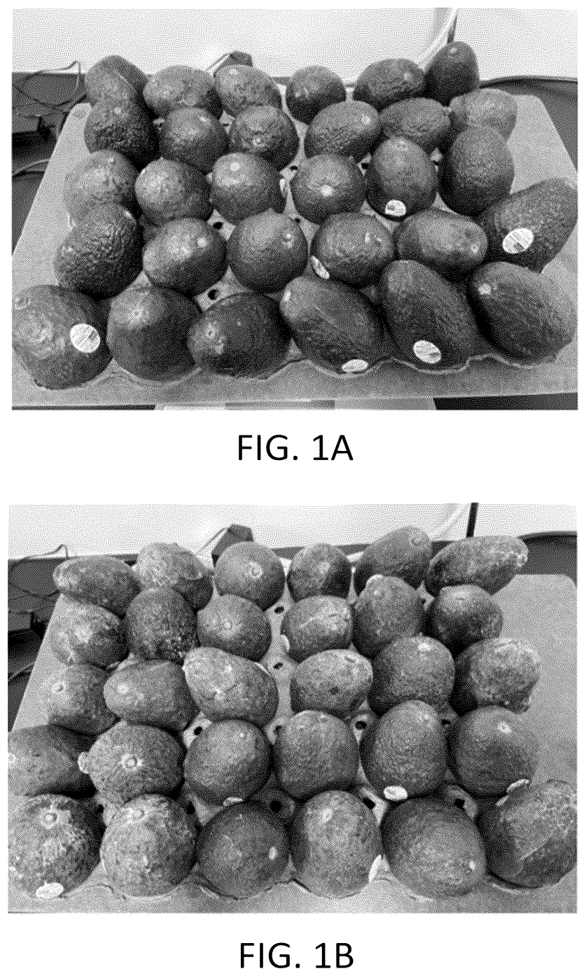

An image of avocados coated with mixture 3 is shown in FIG. 1A, and an image of avocados coated with mixture 4 is shown in FIG. 1B. As shown in in FIGS. 1A and 1B, wax-containing coating agents including a monoglyceride yielded a coating having improved homogeneity and higher gloss as compared to wax-containing coating agents lacking a monoglyceride.

### Example 3. Emulsion Evaluation

Coating agents E-G having the compositions shown in Table 5 were prepared.

TABLE 5
Coating Agents

| | E | F | G |
|---|---|---|---|
| Glyceryl | — | — | 5 wt % |
| Monostearate¹ | | | |
| Sodium Stearate | — | 6.5 wt % | 22.5 wt % |
| Beeswax² | 100 wt % | 93.5 wt % | 72.5 wt % |

¹mixture of 2,3-dihydroxypropan-1-yl octadecanoate and 1,3-dihydroxypropan-2-yl octadecanoate (molar ratio of 2,3-dihydroxypropan-1-yl octadecenoate:1,3-dihydroxypropan-2-yl octadecanoate of about 85:15 to about 95:5)
²refined beeswax (Sigma Aldrich 243248; CAS no. 8012-89-3)

Mixtures 5-7 of coating agents E-G dispersed in water at the concentrations shown in Table 6 were prepared. Each of mixtures 5-7 was subjected to consecutive filtrations (11 μm to 0.2 μm) and then lyophilized to determine the percentage of emulsed solids present in each mixture after filtration. Results are shown in Table 6.

TABLE 6
Mixtures

| | | | Emulsed |
|---|---|---|---|
| | Coating Agent | Concentration | Solids¹ |
| Mixture 5 | E | 40 g/L | 1.18% |
| Mixture 6 | F | 31 g/L | 90.9% |
| Mixture 7 | G | 40 g/L | 94.8% |

¹Mass of coating agent after filtration and lyophilization relative to mass of coating agent added to the mixture

As shown in Table 6, wax-containing coating agents including a fatty acid salt formed improved emulsions as compared to wax-containing coating agents lacking a fatty acid salt.

### Example 4. Performance Mapping of Wax-Containing Compositions

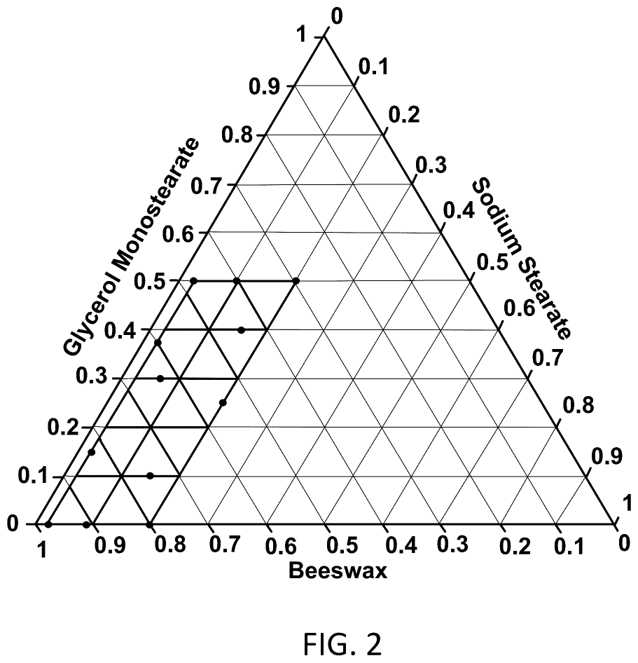

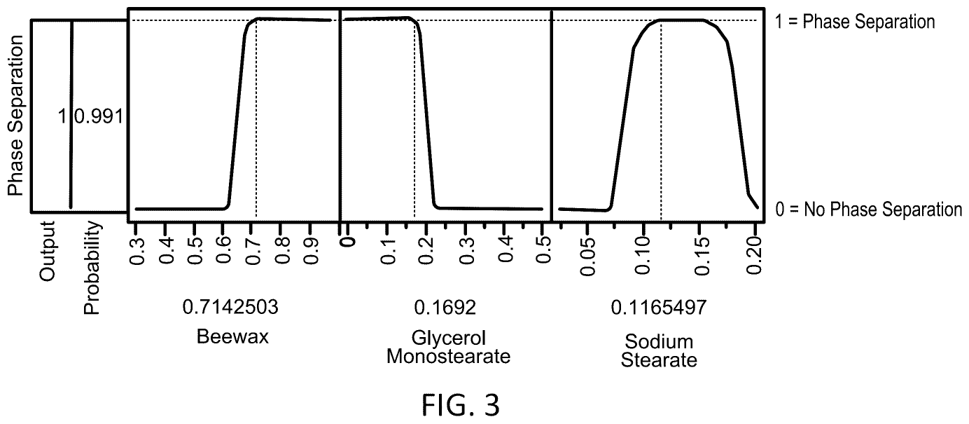

A scheffe cubic mixture design of experiment (DoE) was performed for coatings formed from a coating agent including combinations of beeswax (mass fraction 0-1), glyceryl monostearate (mass fraction 0-0.5), and sodium stearate (mass fraction 0.025-0.2) dispersed in water (30 g/L). The initial design space is shown in FIG. 2. Colloidal dispersions of each composition indicated in FIG. 2 (black dots) were visually inspected for phase separation. The result profile for phase separation (1=phase separation; 0=no phase separation) of the colloidal dispersions as a function of mass fraction of beeswax, glycerol monostearate, and sodium stearate are shown in FIG. 3.

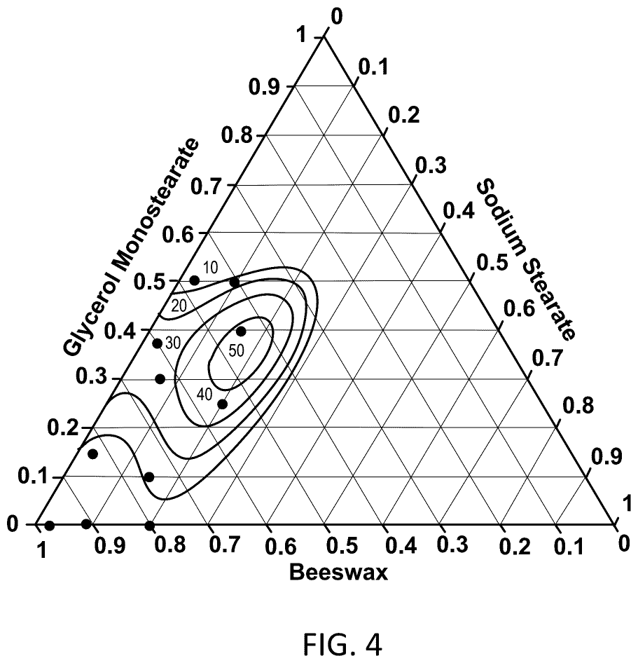

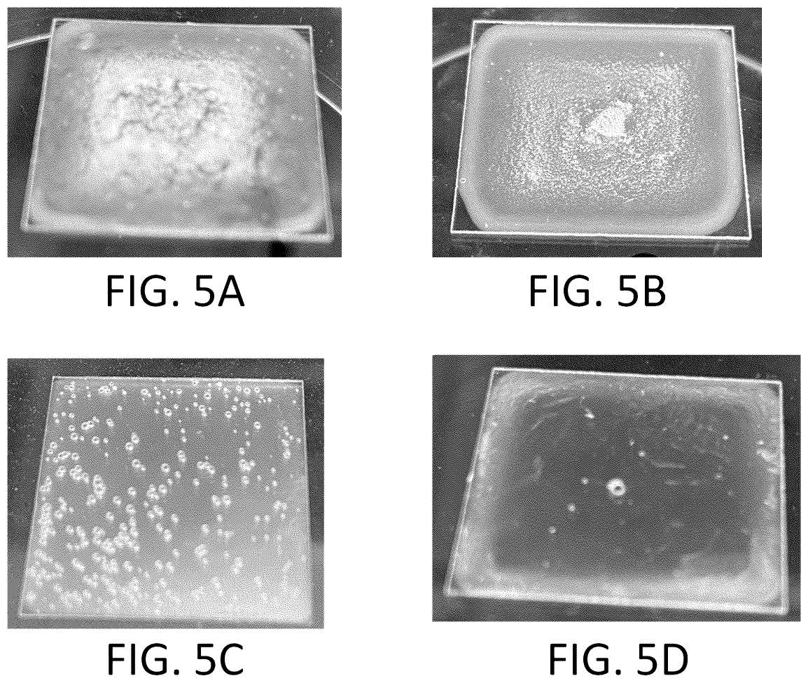

About 0.6 mL of each colloidal dispersion was coated onto a glass slide, which was then dried overnight in an oven at about 40° C. After drying, the gloss level of each coated slide was measured twice using a handheld gloss meter (Horiba), rotating 90° between measurements. Generally, levels up to about 30 were considered low gloss, levels greater than about 30 and up to about 40 were considered medium gloss, and levels greater than about 40 were considered high gloss. The ternary plot of gloss level over the design space is shown in FIG. 4. FIGS. 5A and 5B show low-gloss coatings formed from a coating agent including 91.2 wt % beeswax and 8.8 wt % sodium stearate; 75.3 wt % beeswax, 10 wt % glycerol monostearate, and 14.8 wt % sodium stearate, respectively. FIG. 5C shows a medium-gloss coating formed from 63.4 wt % beeswax, 30 wt % glycerol monostearate, and 6.6 wt % sodium stearate. FIG. 5D shows a high-gloss coating formed from 44.5 wt % beeswax, 40 wt % glycerol monostearate, and 15.5 wt % sodium stearate. As shown in FIG. 4 and FIGS. 5A-5D, varying relative amounts of wax, monoglycerides, and fatty acid salts yielded coatings having varying gloss levels.

### Example 5. Coated Avocados

Coating agents H—N having the compositions shown in Tables 7 and 8 were prepared.

TABLE 7
Coating Agents

| | H | I | | J | | K | | L | M | |
|---|---|---|---|---|---|---|---|---|---|---|
| Glyceryl | 25 wt % | 40 | wt % | 30 | wt % | 15 | wt % | — | — | |
| Monostearate¹ | | | | | | | | | | |
| Sodium | 20 wt % | 15.5 | wt % | 6.6 | wt % | 2.5 | wt % | 20 wt % | 2.5 | wt % |
| Stearate | | | | | | | | | | |
| Beeswax² | 55 wt % | 44.5 | wt % | 63.4 | wt % | 82.5 | wt % | 80 wt % | 97.5 | wt % |

¹mixture of 2,3-dihydroxypropan-1-yl octadecanoate and 1,3-dihydroxypropan-2-yl octadecanoate (molar ratio of 2,3-dihydroxypropan-1-yl octadecenoate:1,3-dihydroxypropan-2-yl octadecanoate of about 85:15 to about 95:5)
²refined beeswax (Sigma Aldrich 243248; CAS no. 8012-89-3)

TABLE 8
Coating Agents

| | N |
|---|---|
| Glyceryl | 90.5 wt % |
| Monostearate¹ | |
| Glyceryl | 4.75 wt % |
| Monolaurate² | |
| Sodium Stearate | 4.75 wt % |

¹mixture of 2,3-dihydroxypropan-1-yl octadecanoate and 1,3-dihydroxypropan-2-yl octadecanoate (molar ratio of 2,3-dihydroxypropan-1-yl octadecenoate:1,3-dihydroxypropan-2-yl octadecanoate of about 85:15 to about 95:5)
²mixture of 2,3-dihydroxypropan-1-yl laurate and 1,3-dihydroxypropan-2-yl laurate (molar ratio of 2,3-dihydroxypropan-1-yl laurate:1,3-dihydroxypropan-2-yl laurate of about 85:15 to about 95:5)

Mixtures 8-14 of coating agents H-M dispersed in water at the concentrations shown in Table 9 were prepared. For each of mixtures 8-14, avocados were coated by dipping into a bowl of the mixture and then drying in a heat tunnel at about 70 ° C. (residence time 90-100 sec.). Mass loss of the coated avocados and a comparative group of uncoated avocados was then measured under ambient conditions. Results are shown in Table 9.

TABLE 9
Mixtures; Mass Loss of Avocados

| | | | Mass Loss |
|---|---|---|---|
| | Coating Agent | Concentration | Factor |
| Mixture 8 | H | 40 g/L | 1.53 |
| Mixture 9 | I | 40 g/L | 1.41 |
| Mixture 10 | J | 40 g/L | 1.89 |
| Mixture 11 | K | 40 g/L | 1.43 |
| Mixture 12 | L | 40 g/L | 1.89 |
| Mixture 13 | M | 40 g/L | 1.54 |
| Mixture 14 | N | 40 g/L | — |
| Untreated | — | — | 1 |

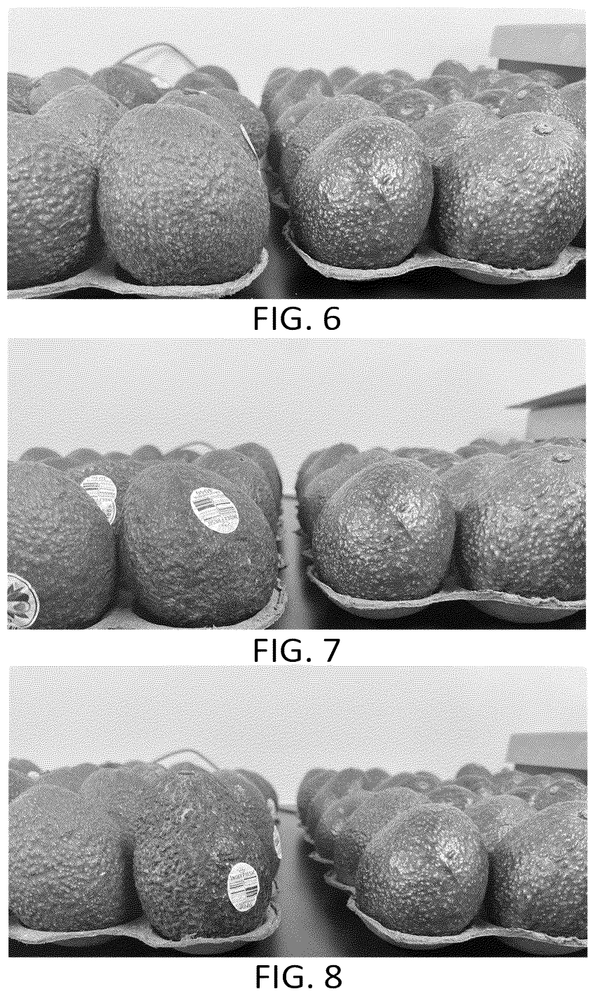

FIG. 6 compares (left) untreated avocados with (right) avocados coated with mixture 8. As shown in FIG. 6, the coated avocados had a higher gloss level as compared to the untreated avocados. FIG. 7 compares (left) avocados coated with mixture 11 with (right) avocados coated with mixture 8. As shown in FIG. 7, avocados coated with mixture 11 had a lower gloss level as compared to avocados coated with mixture 8. FIG. 8 compares (left) avocados coated with mixture 13 with (right) avocados coated with mixture 8. As shown in FIG. 8, avocados coated with mixture 11 had a significantly lower gloss level as compared to avocados coated with mixture 8. The results in FIGS. 6-8 and Table 8 show that the coating agents yielded coatings having varying gloss levels (e.g., from high gloss with coating agent H, to low gloss with coating agent M) but similar, acceptable barrier properties.

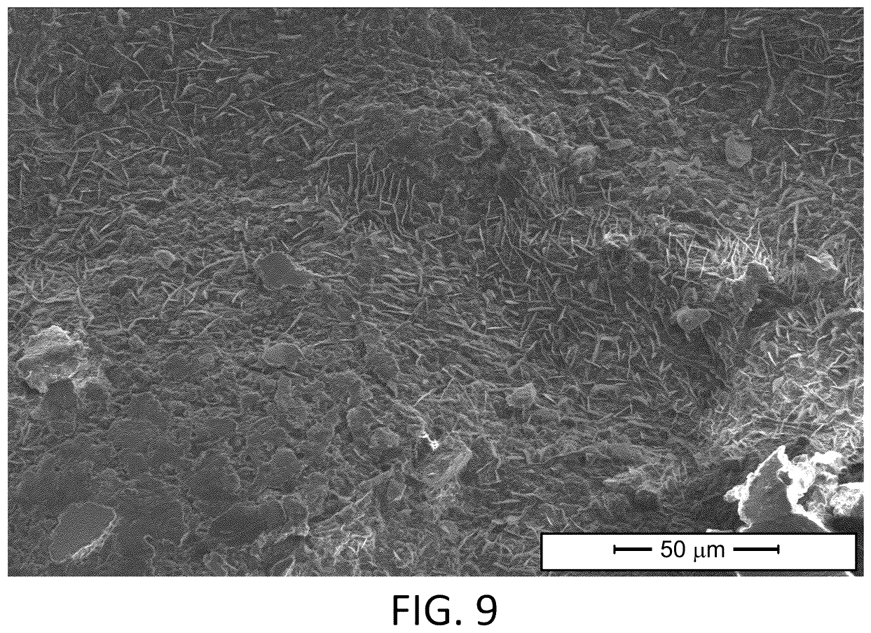

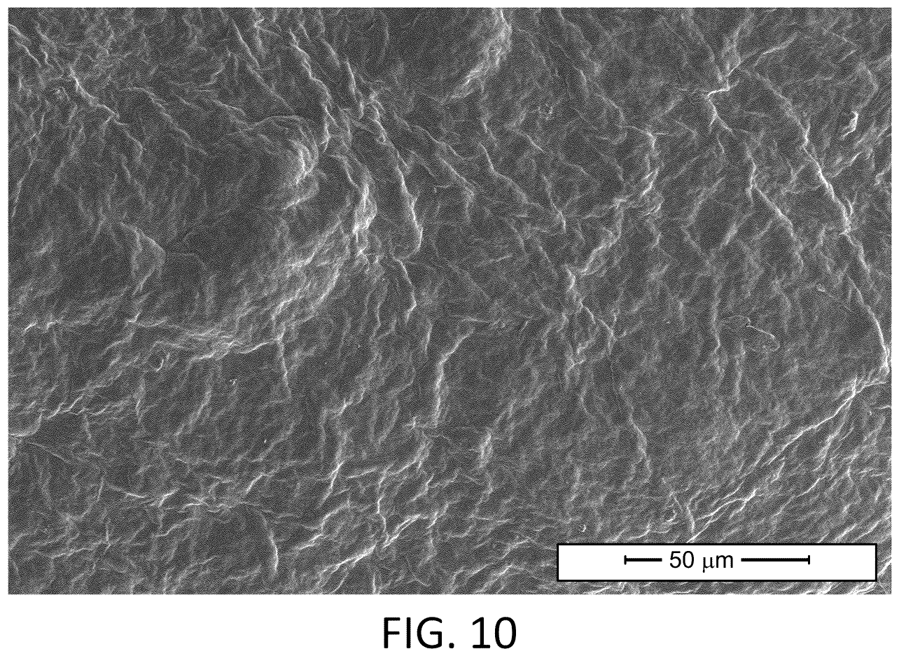

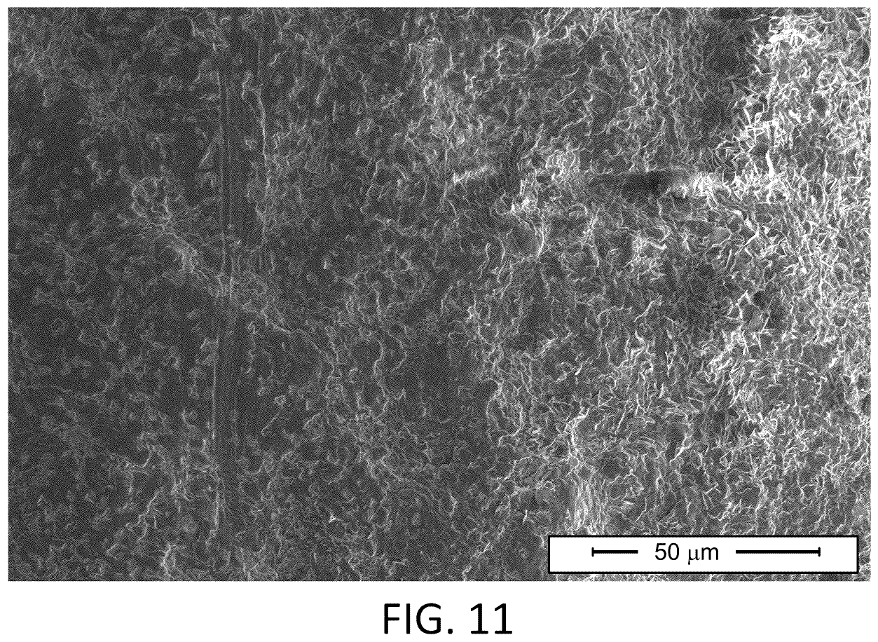

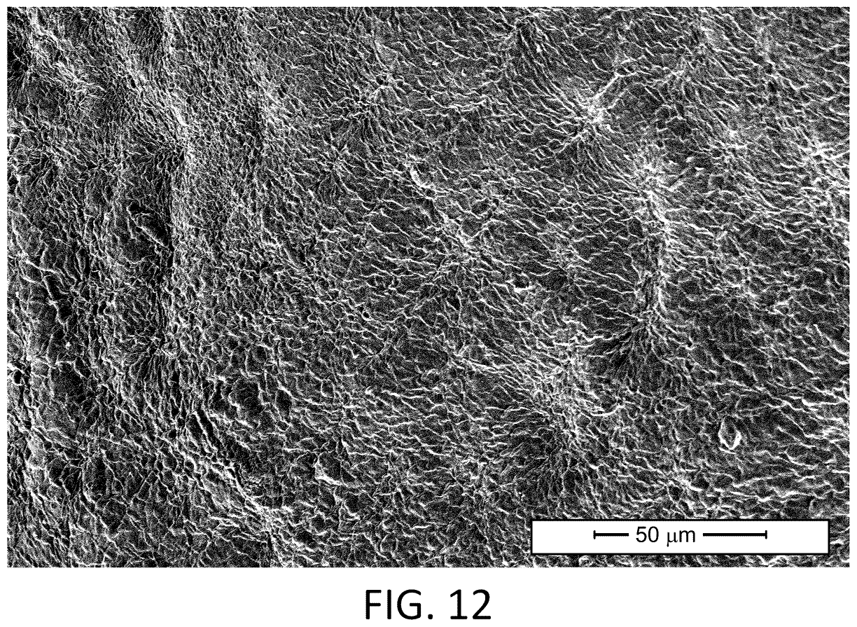

The surfaces of untreated avocados and avocados coated with mixtures 8, 12, and 14 were imaged using scanning electron microscopy (SEM). Results are shown in FIG. 9 (Everhart-Thornley Detector (ETD); high voltage (HV) 5.00 kV; spot 4.0; magnification 500x; working distance (WD) 3.8 mm; horizontal field width (HFW) 254 μm; tilt 0°, FIG. 10 (ETD; HV 3.00 kV; spot 2.0; magnification 500×; WD 8.4 mm; HFW 254 μm; tilt 0°, FIG. 11 (ETD; HV 3.00 kV; spot 2.0; magnification 650×; WD 14.8 mm; HFW 195 μm; tilt 0°, and FIG. 12 (ETD; HV 3.00 kV; spot 2.0; magnification 500×; WD 8.5 mm; HFW 254 μm; tilt 0°, respectively. As shown in FIGS. 9-12, coatings formed from coating agents including beeswax were relatively smooth as compared to coatings from coating agents lacking beeswax, and as compared to the platelet-covered surface of untreated avocados.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

1. A composition comprising:
a wax, present in an amount of about 20 wt % to about 98 wt % of the composition; and
one or more salts of a C₄-C₂₈ fatty acid, present in a total amount of about 2 wt % to about 40 wt % of the composition.

2. The composition of claim 1, wherein:
the wax is present in an amount of about 75 wt % to about 98 wt % of the composition; and
the one or more salts are present in a total amount of about 2 wt % to about 25 wt % of the composition.

3. The composition of claim 1, further comprising one or more monoglycerides of a C₄-C₂₈ fatty acid.

4. The composition of claim 3, wherein:
the wax is present in an amount of about 58 wt % to about 75 wt % of the composition;
the one or more salts are present in a total amount of about 2 wt % to about 25 wt % of the composition; and
the one or more monoglycerides are present in a total amount of about 10 wt % to about 40 wt % of the composition.

5. The composition of claim 3, wherein:
the wax is present in an amount of about 35 wt % to about 60 wt % of the composition;
the one or more salts are present in a total amount of about 10 wt % to about 30 wt % of the composition; and
the one or more monoglycerides are present in a total amount of about 15 wt % to about 35 wt % of the composition.

6. The composition of claim 1, wherein the wax comprises beeswax, carnauba wax, candelilla wax, sunflower wax, or any combination thereof.

7. The composition of claim 1, wherein the wax comprises one or more wax esters.

8. The composition of claim 7, wherein one or more of the wax esters independently comprises a compound of Formula III: 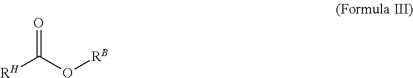
wherein:
each R^{B} is:
C₂₄-C₃₂ alkyl or C₂₄-C₃₂ alkenyl, each optionally substituted with 1-3 R^{C}; or
—R^{H}C(O)OR^{D};
each R^{C} is independently —OH, —C(O)OR^{D}, or —OC(O)R^{H};
each R^{D} is H or R^{B}; and
each R^{H} is independently a C₁₁-C₁₉ side chain optionally substituted with 1-3 R^{C}.

9. The composition of claim 7, wherein the wax further comprises one or more compounds of Formula IV: 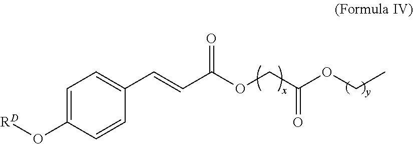
wherein:
R^{D} is H or C₁ alkyl; and
the sum of x and y is from 28 to 88.

10. The composition of claim 1, wherein each of the one or more salts present in the composition independently comprises a compound of Formula II: 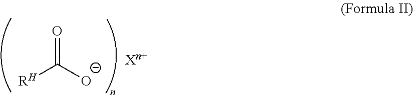
wherein:
R^{H} is a C₃-C₂₇ side chain; and
Xⁿ⁺ is a cationic moiety having formal charge n.

11. The composition of claim 3, wherein each of the one or more monoglycerides independently comprises a compound of Formula I-i or Formula I-ii: 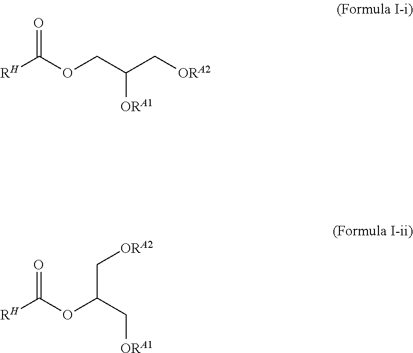
wherein:
R^{A1} and R^{A2} are each independently selected from H and C₁-C₆ alkyl; and
R^{H} is a C₃-C₂₇ side chain.

12. The composition of claim 11, wherein the one or more monoglycerides comprise:
a first compound of Formula I-i or Formula I-ii, wherein R^{H} is a C₁₅-C₂₇ side chain; and
a second compound of Formula I-i or Formula I-ii, wherein R^{H} is a C₃-C₁₃ side chain.

13. A mixture comprising:
the composition of claim 1; and
a solvent.

14. A coated agricultural product comprising an agricultural product and a layer disposed on a surface of the agricultural product, wherein the layer comprises the composition of claim 1.

15. A method of coating an agricultural product, the method comprising:
contacting a surface of the agricultural product with a mixture comprising a coating agent and a solvent, wherein the coating agent comprises:
a wax, present in an amount of about 20 wt % to about 98 wt % of the coating agent; and
one or more salts of a C₄-C₂₈ fatty acid, present in a total amount of about 2 wt % to about 40 wt % of the coating agent; and
removing at least a portion of the solvent to form a coating on the surface of the agricultural product.

16. The method of claim 15, wherein the wax comprises beeswax, carnauba wax, candelilla wax, sunflower wax, or any combination thereof.

17. The method of claim 15, wherein:
the wax is present in an amount of about 75 wt % to about 98 wt % of the coating agent; and
the one or more salts are present in an amount of about 2 wt % to about 25 wt % of the coating agent.

18. The method of claim 15, wherein the coating agent further comprises one or more monoglycerides of a C₄-C₂₈ fatty acid.

19. The method of claim 18, wherein:
the wax is present in an amount of about 58 wt % to about 75 wt % of the coating agent;
the one or more salts are present in a total amount of about 2 wt % to about 25 wt % of the coating agent; and
the one or more monoglycerides are present in a total amount of about 10 wt % to about 40 wt % of the coating agent.

20. The method of claim 18, wherein:
the wax is present in an amount of about 35 wt % to about 60 wt % of the coating agent;
the one or more salts are present in a total amount of about 10 wt % to about 30 wt % of the coating agent; and
the one or more monoglycerides are present in a total amount of about 15 wt % to about 35 wt % of the coating agent.
